(19) United States
(12) Patent Application Publication
(10) Pub. No.: US 2024/0373824 A1
(43) Pub. Date: Nov. 14, 2024

(54) HEEL LEASH APPARATUS

(71) Applicant: Sporn Pet Products, Inc., New York, NY (US)

(72) Inventor: Joseph SPORN, New York, NY (US)

(21) Appl. No.: 18/661,469

(22) Filed: May 10, 2024

Related U.S. Application Data
(60) Provisional application No. 63/465,442, filed on May 10, 2023.

(51) Int. Cl. A01K 27/00

(52) U.S. Cl. CPC A01K 27/003

(57) ABSTRACT

A heel leash may have a primary handle, a handle connection, a multi-handle leash section, a leash end and a harness connector. The multi-handle leash section may have a plurality of possible handles, where each of the handles is at a different distance to the leash end. In use, the heel leash allows a person to grab the primary handle or one of the plurality of handles of the multi-handle leash section, which provides flexibility in selecting a desired effective length (length between the selected handle and the leash end) of the heel leash. A longer effective length may be appropriate for a shorter dog and/or a dog that is behaving, while a shorter effective length may be appropriate for a taller dog and/or a dog that is misbehaving.

### CROSS-REFERENCE TO RELATED APPLICATIONS

This patent application is related to and claims the benefit of U.S. Provisional Patent Application No. 63/465,442 filed on May 10, 2023, titled Heel-X Leash Apparatus, Method of Making and Using the Same, which is hereby fully incorporated by reference.

### FIELD OF THE INVENTION

The present invention relates to an apparatus to be used while walking a dog.

### BACKGROUND

Apparatus specifically designed to control and walk a dog are known. For example, a dog harness is a piece of equipment comprising one or more straps that surround the dog's torso. The harness may be used to control the movements of a dog in a safe and humane manner. The harness may reduce undesirable tension on the neck of the dog while maintaining freedom of movement for the dog. The harness may also be designed to efficiently utilize a dog's pulling power, without hurting the dog.

A leash, sometimes referred to as a lead, lead line or tether, may be attached to the harness and used by a person to guide and control the dog. The leash may be made of one or more different materials, such as rope, leather or chain. The length of the leash controls the maximum distance the dog can be from the human holding the leash. The person may control the movements of the dog through movements of the leash (and possibly voice commands). With practice and training (of both the person and the dog), the person may exercise a great deal of control over the movements of the dog with small and controlled movements from the leash.

### SUMMARY OF THE INVENTION

Accordingly, the invention is directed to a heel leash that allows a person to select from a plurality of available handles with different effective leash lengths to safely and securely control a dog.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

A heel leash may have a primary handle, a handle connection, a felt padding section, a multi-handle leash section, a leash end and a harness connector.

The multi-handle leash section may be connected to the primary handle via either the handle connection or the handle connection and the optional felt padding section. The multi-handle leash section may be constructed in any manner that produces a plurality of possible handles where each of the handles of the multi-handle leash section is at a different distance to the leash end. The multi-handle leash section preferably includes at least two other handles (in addition to the primary handle), but may include three, four, five, six, seven or more additional handles, with each lower handle effectively shortening up the heel leash to provide greater control over the dog by the person using the heel leash.

In use, the heel leash is configured to allow a person to easily grab the primary handle or one of a plurality of different handles of the multi-handle leash section. This provides the person controlling a dog a great deal of flexibility in selecting a desired effective length (length between the selected handle and an end of the harness connector connected to the harness of the dog) of the heel leash. A longer effective length may be appropriate for a shorter dog and/or a dog that is behaving, while a shorter effective length may be appropriate for a taller dog and/or a dog that is misbehaving.

This Summary section is neither intended to be, nor should be, construed as being representative of the full extent and scope of the present disclosure. Additional benefits, features and embodiments of the present disclosure are set forth in the attached figures and in the description hereinbelow, and as described by the claims. Accordingly, it should be understood that this Summary section may not contain all of the aspects and embodiments claimed herein.

Additionally, the disclosure herein is not meant to be limiting or restrictive in any manner. Moreover, the present disclosure is intended to provide an understanding to those of ordinary skill in the art of one or more representative embodiments supporting the claims. Thus, it is important that the claims be regarded as having a scope including constructions of various features of the present disclosure insofar as they do not depart from the scope of the methods and apparatuses consistent with the present disclosure (including the originally filed claims). Moreover, the present disclosure is intended to encompass and include obvious improvements and modifications of the present disclosure.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view of an animal leash apparatus arranged in accordance with the present design;

FIG. 2 is a rear elevation view of the animal leash apparatus in FIG. 1;

FIG. 3 is a front elevation view of the animal leash apparatus in FIG. 1;

FIG. 4 is a top view of the animal leash apparatus in FIG. 1;

FIG. 5 is a bottom view of the animal leash apparatus in FIG. 1;

FIG. 6 is a left side view of another embodiment of an animal leash apparatus in accordance with the present disclosure;

FIG. 7 is a right side view of the animal leash apparatus in FIG. 6;

FIG. 8 is a perspective view of the animal leash apparatus in FIG. 1;

FIG. 9 is a cross-sectional view and a side view of the heel leash apparatus in FIG. 1; and

FIG. 10 is a flowchart of an example method of using the invention.

### DETAILED DESCRIPTION OF THE ILLUSTRATED EMBODIMENTS

The following detailed description describes an animal leash apparatus, method of using and making the same and is presented to enable any person skilled in the art to make and use the disclosed subject matter in the context of one or more particular implementations. Various modifications, alterations, and permutations of the disclosed implementations can be made and will be readily apparent to those skilled in the art, and the general principles defined may be applied to other implementations and applications, without departing from scope of the disclosure. The present disclosure is not intended to be limited to the described or illustrated implementations, but to be accorded the widest scope consistent with the described principles and features.

For the purposes of promoting an understanding of the principles of the present disclosure, reference will now be made to the exemplary embodiments illustrated in the drawing(s), and specific language will be used to describe the same.

Appearances of the phrases an “embodiment,” an “example,” or similar language in this specification may, but do not necessarily, refer to the same embodiment, to different embodiments, or to one or more of the figures. The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps unless explicitly stated otherwise.

In order to more fully appreciate the present disclosure and to provide additional related features, each of the following references are fully incorporated herein by reference in their entirety:

(1) U.S. Pat. No. 7,497,186 discloses an animal self-carried hydrating system comprises an animal harness, a fluid container for holding the fluid, and a fluid dispensing mechanism. The animal harness is securable on the animal by a fastening system. The animal harness has a fluid pocket for holding the fluid container. The fluid dispensing mechanism is attached to the fluid container, in fluid communication with the fluid in the fluid container. The fluid dispensing mechanism is such that it can dispense fluid from the fluid container to the animal while the fluid container is in the fluid pocket.

(2) U.S. Pat. No. 9,241,474 teaches an animal harness for an animal that includes a loop of webbing, which encircles the back, neck and shoulder of the animal. A pouch is affixed to the loop. A pulsating device is disposed within the pouch and transmits same to the animal through the chest and about its heart to calm the animal during transport.

(3) U.S. Pat. No. 6,568,575 discloses a harness with detachable and interchangeable pouches comprises two torso straps extending downwardly and outwardly from a central coupler assembly, two shoulder straps, and two belly straps. The harness is adjustable to fit nearly any body size. The pouches are attached to the harness with quick-releasing retaining clips and to each other by the belly straps. Each pouch includes front and rear panels that are formed using either a right-side template or a left-side template and is interchangeable with any other pouch designed using the same template. The interchangeability allows the wearer to install pouches that are best suited for a particular activity. Each pouch is designed such that, when worn, it hangs at an angle which causes its top to slant downwardly toward the middle of the wearer's torso, thereby increasing the accessibility of the pouch contents.

(4) U.S. Pub. No. 2017/0215385 relates to a novel pet harness and pack for comfortably harnessing a dog and providing a dispenser for waste bags one on side of the harness and a storage pouch on the opposite side. The pouches are colorfully decorated with character faces and the bags will dispense out of a portion of the character's face. A metal loop is provided beneath a cross-stitched reinforced section of fabric wherein a leash may be attached to the harness.

(5) U.S. Pub. No. 2022/0079119 teaches a retractable leash assembly for a pet animal, such as a dog. The leash assembly includes a casing body with a handle attached to the body by an at least one hinge joint, a braking device, and a spool arrangement with an extendable lead line wound thereabout and configured attachable to the pet animals' collar or harness, wherein in the leash assembly the handle is configured to articulate about the joint with regard to the casing body, the articulation movement of the handle being triggered by the pulling force exerted on the lead line by the animal kept on the leash, and wherein, by virtue of the articulation movement the braking device actuates a braking action causing the lead line to reduce unwinding speed proportionally with an increase in the pulling force.

(6) U.S. publication No. 2022/0167592 relates to a leash extender with a larger round wrist loop and a smaller round handle loop connected by an extension. A user will wrap the leash extender around the handle of a pet leash and pass the wrist loop through the handle loop and pull securely. The leash extender is made of a soft, flexible material and has no edges, so is very comfortable around the user's wrist.

(7) U.S. Pub. No. 2022/0125016 teaches a dog leash that includes a dog leash body. An end of the dog leash body is provided with an annulus structure and forms a traction part. The traction part is provided with a buckle by butt-and-collar joint. The root segment of the traction part is covered with a sheath. The dog leash adapts flexible steel wire rope with good flexibility and high strength. The steel wire rope is coated with plastic layer, which has good touch feeling and high use comfort.

Reference will now be made in detail to an embodiment of the present invention, example of which is illustrated in the accompanying drawings.

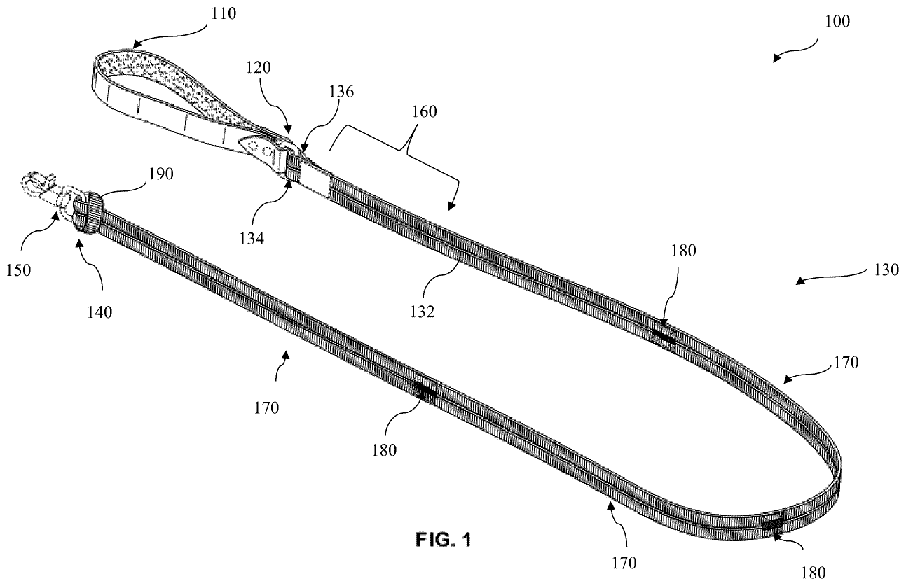

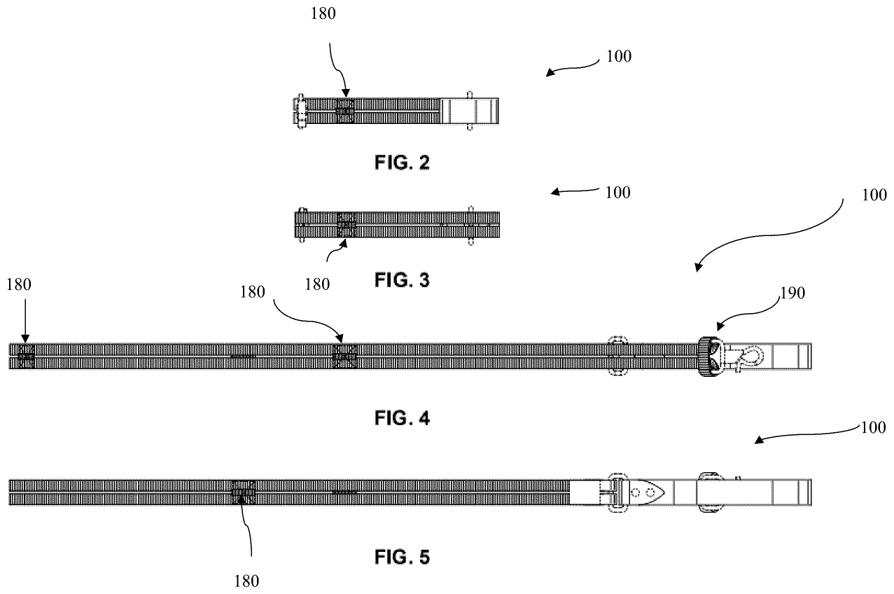

The present invention will now be discussed with reference to FIGS. 1-9, which illustrate various views of a heel leash 100. The heel leash 100 may have a primary handle 110, a handle connection 120, a felt padding section 160, a multi-handle leash section 130, a leash end 140 and a harness connector 150.

The primary handle 110 is at one end of the heel leash 100 and forms a loop configured to receive a person's hand. The primary handle 110 may be made of any desired material. As non-limiting examples, the primary handle 110 may be made of leather, nylon, chain, cotton rope or any combination thereof.

A preferred embodiment of the primary handle 110 is illustrated in FIG. 9. In this embodiment, the primary handle 110 may include an inner plush felt padding 900 surrounded by an outer nylon webbing 910. The inner plush felt padding 900 may act as a lining to the inside of the primary handle 110 for added comfort to the user The felt padding section 160 and/or the multi-handle leash section 130 may comprise a webbing with vinyl piping detail along both side edges.

The width of the primary handle 110 may be any desired width, but in preferred embodiments the width of the primary handle 110 is between one half and two inches and is most preferably either one half an inch or one inch wide.

Referring again to FIGS. 1-5, the primary handle 110 may be connected to the felt padding section 160 or directly to the multi-handle leash section 130 of the heel leash 100 using any desired method. In a preferred embodiment, a handle connection 120 is used to connect the primary handle 110 to either the felt padding section 160 or the multi-handle leash section 130 of the heel leash 100. In a preferred embodiment, illustrated in FIG. 9, the handle connection 120 is made of a vinyl rivet assembly 920 wrapped around a part of the nylon portion (but preferably not the plush felt padding 900) of the primary handle 110. The vinyl rivet assembly 920 may comprise a short vinyl strap 922, between two and five inches, that surrounds and securely holds extra webbing from the primary handle 110 through the use of at least one, and preferably two, rivets 940. The webbing 910 of the primary handle 110 may have extended end portions that project beyond the ends of the padding 900, defining a portion of the webbing 910 through which the rivets 940 can be driven to form a closed loop of the primary handle 110, without piercing the plush felt padding 900. The vinyl rivet assembly 920 may securely connect the primary handle 110 to either the felt padding section 160 or the multi-handle leash section 130 with a metal glide 930 (preferably made of metal). The metal glide 930 may then be attached to the rest of the heel leash 100 as illustrated in FIG. 9.

The metal glide 930 may be a buckle with two apertures. An end of the webbing 910 may thread through a first of the apertures and loops back on itself. The vinyl strap 922 of the vinyl rivet assembly 920 feeds through the second aperture and extends on both sides over the attachment portion of the webbing, and the rivets 940 are driven through all. The proximal/handle end of the multi-handle leash section 130 extends through the second aperture of the metal glide 930 and loops back on and attaches to itself (by, e.g., stitching, thermal weld, rivets or other fasteners, etc.).

Referring again to FIGS. 1-7, in other embodiments, primary handle 110 may be connected to either the felt padding section 160 (if used) or the multi-handle leash section 130 using any desired method. As non-limiting examples, the primary handle 110 may be stitched/box stitched or thermal welded to the felt padding section 160 or the multi-handle leash section 130. In other embodiments, the primary handle 110 may be connected to the felt padding section 160 or multi-handle leash section 130 using any desired type of glide (slip or no-slip buckle), D-ring, or no glide where the primary handle 110 attaches directly to either the felt padding section 160 or the multi-handle leash section 130. In other embodiments, the primary handle 110 may be removably attached to the felt padding section 160 or the multi-handle leash section 130, such as by using snaps or carabiner.

The primary handle 110 may be connected to the rest of the heel leash 100 by any desired method. As a non-limiting example, the primary handle 110 may be an integral part of the rest of the heel leash 100. For example, the strip(s) of the leash section 130 may form the primary handle 110 (e.g., as the outer webbing 910 of FIG. 9). In other embodiments, the primary handle 110 may be a separate piece, i.e., not integral to the heel leash 100 which allows the primary handle 110 to be replaced or exchanged without having to discard the entire heel leash 100. Making the primary handle 110 a separate piece may also simplify the construction process of the heel leash 100.

In some embodiments, the metal glide 930 may be attached to an optional felt padding section 160. In some embodiments, the felt padding section 160 does not have an aperture or slit configured to be a handle. The felt padding section 160, if optionally used, may be any desired length. In some embodiments, the felt padding section 160 may be between six and 24 inches long, but when used is most preferably about nine inches long.

A multi-handle leash section 130 may be connected to the primary handle 110 via either the handle connection 120 or the handle connection 120 and the optional felt padding section 160. The multi-handle leash section 130 may be constructed in any manner that produces a plurality of possible handles where each of the handles of the multi-handle leash section 130 is at a different distance to the leash end 140.

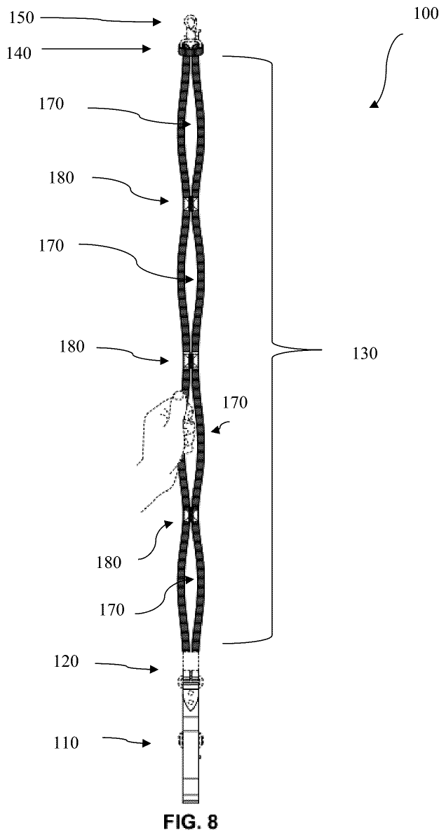

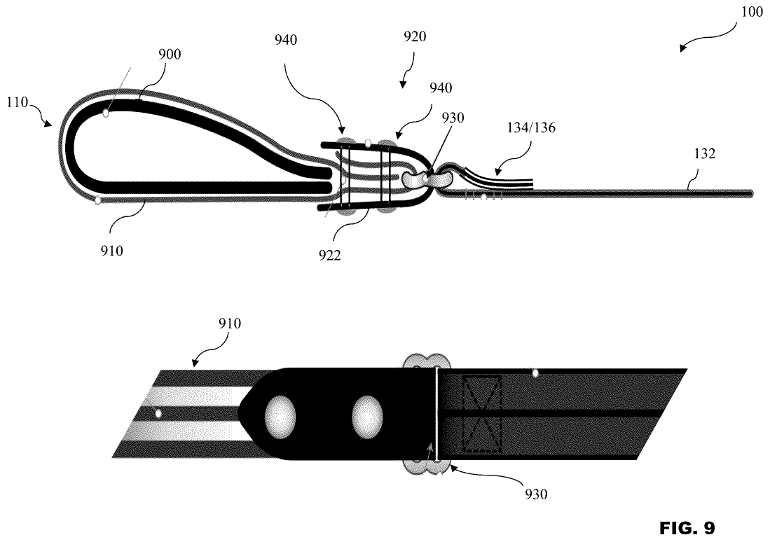

Referring to FIG. 8, the handles 170 of the multi-handle leash section 130 may be created using, as non-limiting examples, apertures, holes or slits in the multi-handle leash section 130. An aperture is formed by interconnecting 180 two adjacent straps leaving an open space between the interconnects. A hole may be formed be removing material from a single strap within its width. A slit may be formed by cutting or slicing through a single strap so that you can put your hand through. As an example construction method, two straps of material may be stacked on top of each other and stitched or welded at a plurality of interconnects 180 on the multi-handle leash section 130. The number of interconnects 180 and the spacing between the interconnects 180 may be adjusted as desired to create the number of handles 800 and the sizes of the handles 800 desired respectively.

The multi-handle leash section 130 preferably includes at least two other handles (in addition to the primary handle 110), but may include three, four, five, six, seven or more additional handles, with each lower handle effectively shortening up the heel leash 100 to provide greater control over the dog by the person using the heel leash 100.

The multi-handle leash section 130 may comprise one strap of material (such as cloth, vinyl, leather, etc.) that has been sliced a desired number of times along a length of the multi-handle leash section 130 to produce a corresponding number of additional slits or handles.

In another embodiment, the multi-handle leash section 130 comprises two strips (or straps) of material (such as cloth, vinyl, leather, etc.) that have been connected a number of times at various points along its length to produce a number of additional handles (apertures or holes). In some embodiments, the interconnects 180 may be uniformly spaced, thereby creating a plurality of handles 170 having a uniform spacing and size. In other embodiments, the interconnects 180 may be spaced as desired to position and size the handles to any desired position and size along the multi-handle leash section 130.

The length of the stitched portions between the handles 170 may be any desired length and creates a space between adjacent handles 170 in the multi-handle leash section 130. Longer spaces between stitched portions, i.e., interconnects 180, will create longer spaces between handles 170 while shorter stitched portions will create shorter spaces between handles 170. The two strips of material may be connected by any desired method, such as by, as a non-limiting example, riveting, stitching (and most preferably by box stitching) the two strips of material together at spaced intervals along the length of the multi-handle leash section 130. In this manner, any number of additional handles 170 may be created on the multi-handle leash section 130 and each additional handle 170 may be spaced as desired and have a different desired distance from the leash end 140.

Referring to FIGS. 1-5 and 8, the multi-handle leash section 130 may in some embodiments be formed from one single nylon strap 132 or similar strip of material, which may be substantially flat (i.e., significantly wider than it is thick). A first end 134 of the strap 132 may attach to the handle connector 120. At the leash end 140, the strap 132 may pass through the harness connector 150 one or more times and may be knotted to itself (forming a knot 190, in some embodiments) or otherwise arranged to securely, and either permanently or removably, attach the strap 132 to the harness connector 150 at the leash end 140. The knot 190 may be configured so that the strap 132 doubles back on and lays flat against itself to form the two strips of the leash section 130 depicted in the embodiment of FIGS. 1-5 and 8. In some embodiments, a second end 136 of the strap 132 (i.e., the other end of the strap 132) attaches to the handle connector 120 next to the first end 134 of the strap 132. In an embodiment, the strap 132 passes through a ring or other component of the handle connector 120 at both the first end 134 and the second end 136, and loops back on and is stitched or otherwise attached to itself at both ends 134, 136, as described above with respect to FIG. 9. Alternatively, the strap 132 may be attached at the ends 140, 134 to the harness connector 150, and the strap 132 may be knotted at the handle connector 120. The adjacent portions of the strap 132 may be stitched together or otherwise connected to each other at the interconnects 180 to form the handles 170—that is, one of the plurality of handles 170 extends from the handle connector 120 (or the end of the padded section 160, if any) to a first of the interconnects 180, the each pair of adjacent interconnects 180 form another of the handles 170 therebetween, and finally a last of the handles 170 extends from the last interconnect 180 to the leash end 140 (i.e., to the knot 190 or the harness connector 150).

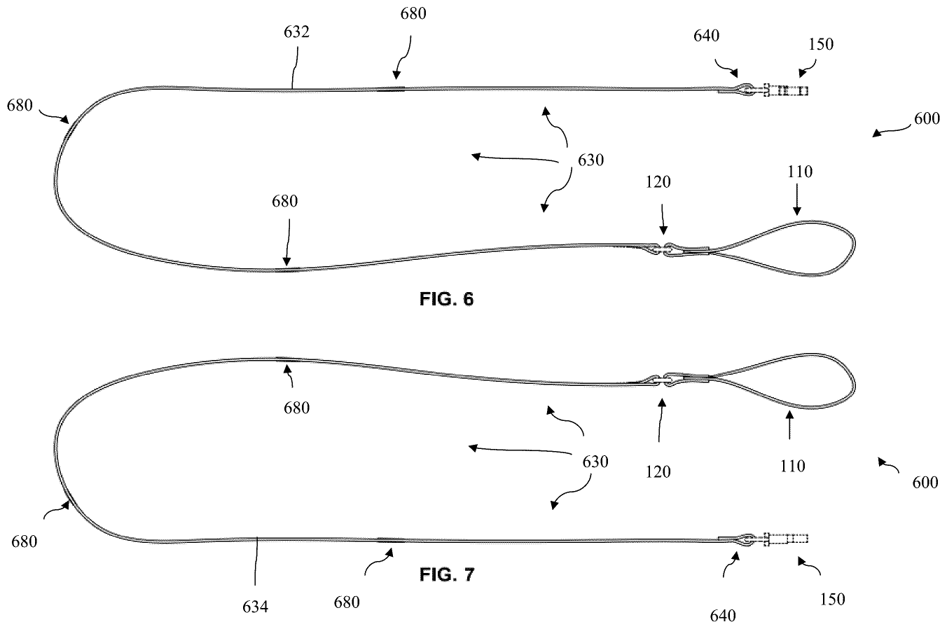

Referring to FIGS. 6 and 7, in another embodiment of the present heel leash 600 a multi-handle leash section 630 does not have a knot 190, but instead using a handle attachment 640. The handle attachment 640 comprises two separate straps (a first strap 632 and a second strap 634) or other strips of leash material fed through a ring of the harness connector 150 where the two strips 632, 634 are either overlayed on themselves (four strips of material) or are laid side-by-side and stitched together to securely attach the multi-handle leash section 630 to the harness connector 150.

The harness connector 150 may be attached to a harness, collar or similar item worn by the dog to control and guide the movements of the dog. The overall length of the heel leash 100, 600 may be any desired length. In preferred embodiments, the length of the heel leash 100, 600 is between 30 inches and 72 inches but is most preferably about 48 inches long.

In use, the heel leash 100, 600 is configured to allow a person to easily grab the primary handle 110 or one of the handles of the multi-handle leash section 130, 680. This provides the person controlling a dog a great deal of flexibility in selecting a desired effective length (length between the selected handle and a leash end 140). A longer effective length may be appropriate for a shorter dog or a dog that is behaving, while a shorter effective length may be appropriate for a taller dog or a dog that is misbehaving.

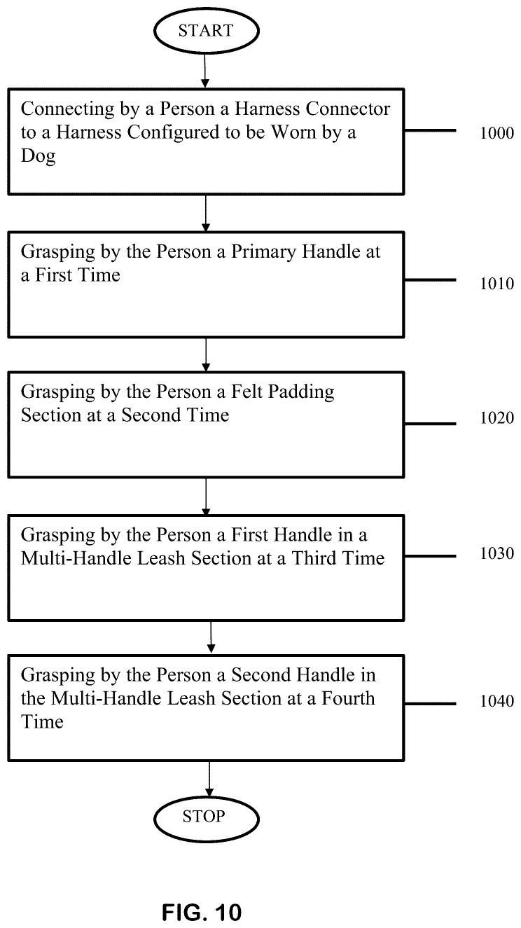

Referring to FIG. 10, an example method for a person to use the presently described heel leash 100 is illustrated. At 1000, the person using the using the heel leash 100 may connect the harness connector 150 to a harness worn by a dog in preparation for walking or training the dog. At 1010, the person using the heel leash 100 may grasp a primary handle 110 at a first time. The primary handle 110 provides the maximum leash length to the dog. This may be used when the user wishes to give the dog the maximum level of freedom to move around, but provides the user with the lowest degree of control of the dog that the heel leash 100 can provide.

At 1020, if the heel leash 100 has a felt padding section 160 as described above, the person using the heel leash 100 may grasp the felt padding section 160 at a second time. This provides a shorter heal leash 100 than when the user uses the primary handle 110, but still gives the user some level of comfort and a little more control over the dog, since the felt padding section 160 is closer to the dog than the primary handle 110. A first terminal end of the felt padding section 160 may be connected to the primary handle 110 by a handle connection 120 and a second terminal end of the felt padding section 160 may be connected to a multi-handle leash section 130.

at 1030, the person using the heel leash 100 may grasp a first handle in the multi-handle leash section 130 at a third time. The multi-handle leash section 130 provides a plurality of handles 170. The user may select a handle 170 closer to the dog, i.e., the leash end 140/harness connector 150 when additional control over the dog is desired or a handle 170 that is further away from the dog, i.e., leash end 140/harness connector 150 when the user wants a longer effective heel leash 100. At 1040, the person using the heel leash 100 may grasp a second handle in the multi-handle leash section 130 at a fourth time as the needs of the user changes. Specifically, a handle 170 closer to the dog is selected when more control is needed or further away when less control over the dog is needed. There may also be times when the person wishes to use both hands in controlling their dog and may use a first handle 170 with their left hand and a second handle 170 with their right hand.

In some embodiments, the heel leash 100 may not have the felt padding section 160. In such an embodiment, the handle connection 120 is connected directly to the multi-handle leash section 130.

The start of the first time, the second time, the third time and the fourth time may be at the same or, preferably, at different times. The length of the first time, the second time, the third time and the fourth time may be of any desired length of time and may have the same, or preferably, different lengths of time. The first time, the second time, the third time and the fourth time may occur in any desired chronological order. The first time, the second time, the third time and the fourth time may or may not have overlapping times as desired.

The inventions and methods described herein can be viewed as a whole, or as a number of separate inventions, that can be used independently or mixed and matched as desired. All inventions, steps, processed, devices, and methods described herein can be mixed and matched as desired. All previously described features, functions, or inventions described herein or by reference may be mixed and matched as desired.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A heel leash for controlling a dog, comprising:
a primary handle formed from a loop of material;
a multi-handle leash section connected to the primary handle, wherein the multi-handle leash section comprises at least two apertures in the multi-handle leash section configured to be used as handles; and
a harness connector connected to the multi-handle leash section.

2. The heel leash of claim 1, wherein the multi-handle leash section is made from a single continuous piece of material with a plurality of slits, where each slit is configured to be used as a handle.

3. The heel leash of claim 1, wherein the multi-handle leash section is made from two pieces of continuous material connected together at intervals by stitching to thereby form apertures in the multi-handle leash section, where each aperture is configured to be used as a handle.

4. The heel leash of claim 1, wherein the multi-handle leash section is made from a single continuous piece of material arranged into adjacent portions that are stitched together at a plurality of interconnects, the multi-handle leash section comprising one or more apertures between the adjacent portions, where each aperture is configured to be used as a handle.

5. The heel leash of claim 4, wherein the single continuous piece of material comprises a nylon strap knotted to the harness connector at a leash end, so that the nylon strap doubles back on itself to form the adjacent portions that are stitched together at the interconnects to form the handles.

6. The heel leash of claim 1, wherein the multi-handle leash section has four apertures configured to be used as four handles.

7. The heel leash of claim 1, wherein the multi-handle leash section is made from two pieces of non-continuous material connected together at even intervals by stitching at interconnect points to thereby form apertures in the multi-handle leash section, wherein each aperture is configured to be used as a handle.

8. The heel leash of claim 1, wherein the multi-handle leash section is made from two pieces of non-continuous material connected together at uneven intervals by stitching at interconnect points to thereby form apertures in the multi-handle leash section, wherein each aperture is configured to be used as a handle.

9. The heel leash of claim 1, further comprising:
a handle connector configured to removably attach the primary handle to the multi-handle leash section.

10. The heel leash of claim 1, further comprising:
a handle connector configured to non-removably attach the primary handle to the multi-handle leash section.

11. A heel leash for controlling a dog, comprising:
a primary handle formed from a loop of material;
a multi-handle leash section connected to the primary handle, wherein the multi-handle leash section comprises a plurality of handles, wherein the multi-handle leash section is made from a single continuous piece of material that is overlayed on itself and stitched at interconnects to thereby form apertures in the multi-handle leash section, where each aperture is configured to be used as a handle; and
a harness connector connected to the multi-handle leash section.

12. The heel leash of claim 11, wherein the multi-handle leash section has four apertures configured to be used as four handles.

13. The heel leash of claim 11, wherein the multi-handle leash section comprises a single continuous nylon strap knotted to the harness connector at a leash end, so that the nylon strap doubles back on itself to form two layers of the single continuous nylon strap that are stitched together at the interconnects to form handles.

14. The heel leash of claim 11, wherein the multi-handle leash section has four apertures configured to be used as four handles.

15. A method of controlling a dog during a walk, comprising the steps of:
connecting a heel leash to a harness or a collar worn by the dog, the heel leash comprising:
a primary handle formed from a loop of material;
a multi-handle leash section connected to the primary handle, wherein the multi-handle leash section comprises a plurality of handles, wherein the multi-handle leash section is made from a single continuous piece of material that is overlayed on itself and stitched at interconnects to thereby form apertures in the multi-handle leash section, where each aperture is configured to be used as a handle; and
a harness connector connected to the multi-handle leash section and configured to connect to the harness or collar of the dog;
grasping the primary handle at a first time;
grasping a first handle in the multi-handle leash section at a third time; and
grasping a second handle in the multi-handle leash section at a fourth time.

16. The method of claim 15, wherein the heel leash further comprises a felt padding section connected to the primary handle and to the multi-handle leash section, the method further comprising the step of grasping the felt padding section at a second time.

17. The method of claim 15, wherein the third time and the fourth time are at overlapping time periods.

18. The method of claim 15, wherein the first time, the third time and the fourth time are at different non-overlapping time periods.

19. The method of claim 15 wherein the first time, the third time and the fourth time are at different overlapping time periods.

20. The method of claim 15, wherein the first time, the third time and the fourth time do not happen in chronological order.
